(19) United States
(12) Patent Application Publication
(10) Pub. No.: US 2003/0061107 A1
(43) Pub. Date: Mar. 27, 2003

(54) Supplier data transfer system and method

(76) Inventors: Yun-Chi Lee, Taipei (TW); Yi-Ming Liao, Taipei (TW); Kou-Ching Hong, Taipei (TW); Tzu-Cheng Hsu, Taipei (TW); Cheng-Ju Chen, Taipei (TW); Te-Mei Chu, Taipei (TW)

Correspondence Address: BIRCH STEWART KOLASCH & BIRCH, PO BOX 747, FALLS CHURCH, VA, 22040-0747, US

(21) Appl. No.: 09/956,955

(22) Filed: Sep. 21, 2001

(51) Int. Cl. G06F 17/60

(52) U.S. Cl. 705/26

(57) ABSTRACT

A supplier data transfer system and method aims at resolving the problem of not able to not transfer data timely in a configure-to-order fashion by Electronic Data Interchange (EDI). Through a platform provided by an information intermediary, data formats are transferred during data file transfer processes and data formats are formed in a configure-to-order fashion, thereby may reduce transfer delay time and enhance data format compatibility.

### FIELD OF THE INVENTION

This invention relates to a supplier data transfer system and method, and particularly a supplier data transfer system and method that is capable of transferring data formats in a configure-to-order fashion during the file data transfer process.

### BACKGROUND OF THE INVENTION

Since the Internet was opened to commercial applications in 1991, it has become a heavily focused subject. A wide variety of applications have been developed and introduced that try to take full advantage of the power of the Internet. For instance, network shopping, online services, distance learning, and the like have been widely covered and discussed in the press and mass media. In a very short period of time, it seems that anything Internet-related becomes hot and attracts a lot of attention. In fact, the network economy has become a huge market in recent years. In the past, when people evaluated the impact of Internet on businesses, most tended to focus mainly on the network transaction area. However, under the increasing pressure of globalization, with a focus on efficiency and being customer driven, the Internet has gradually permeated companies' internal business processes, and changed their relationship with other manufacturers and business partners. The Internet has made a great impact on nearly every aspect of enterprise operations.

Value Added Network (VAN) is a product resulting from the expanding of the basic network function. The greatest difference between the VAN and the basic network is that the latter mainly includes general network lines or modems, but the former adds more service items on the basic network to create additional value. For instance, some VANs provide Electronic Data Interchange (EDI) and E-mail services. Other VANs offer calculation processes and statistical analysis functions. In short, VANs are adding services users need or want to the basic network.

The VAN is built on a proprietary network and has greater security and stability. However, its openness is relatively limited. Hence, different networks cannot be linked directly. It requires different lines and a security authentication mechanism to function properly.

As a VAN usually costs much more than the Internet, due to cost considerations, many companies transfer part of their business to the Internet. Nevertheless, VANs are still being heavily used within industries that need a high level of security and stability, such as banks, as the Internet still has reliability problems, such as its inability to track messages, unplanned communication interruption, or the like. On the other hand, VANs have functions such as VAN central mail-box management, and message tracking , and are basically high reliability information systems. Moreover, business is traditionally a one-to-many relationship, and it is difficult for an enterprise to maintain these complex communication relationships on its own. Hence, it is more desirable to employ VANs service providers to provide a single contact point.

At the initial developmental stages of electronic commerce, some people predicted that the middlemen or intermediaries would 1 gradually fade away when the network became popular. Their reasoning was that the Internet is a frictionless trading environment, and any consumer can directly contact the producers to conduct business without being exploited by middlemen. However, the evolution of business in recent years has shown that it has not turned out that way. First, electronic commerce has not progressed as smoothly as predicted. Because of the legal environment and security concerns, most consumers are still inclined to shop by traditional methods. Second, the information flooding the Internet includes much that is superficial, lacking substance and dubious in value, and Web sites do not offer adequate classification mechanisms and search engines to ensure the quality or utility of information. Consumers often get lost in the vast ocean of data and information. Thus, the intermediaries (including channel and distribution vendors) still enjoy brisk business. Ironically, the overload of information even creates the need for impartial and objective third parties to cull and remake information for consumer use. This opens a window of opportunity for traditional middlemen and brokers who have proper strategies to become information intermediaries.

Information intermediaries provide the function of selling market information and creating platforms to smooth business transactions between buyers and sellers. They do not have fixed customers or suppliers, but depend on the network relationship they have painstakingly established. As they are at advantage point between the suppliers and customers, they are able to get valuable information from both sides that is not available to other parties. Hence, they can create added value for their information, and attract more suppliers and customers. This phenomenon can snowball and reinforce itself to generate a self-feeding effect.

As to EDI, it is a means of information exchange that uses standardized data formats and is done electronically between organizations. Its application is not limited to enterprises, as governments, hospitals, schools and the like can all use EDI to exchange information. It can save administrators and managers a great deal of paperwork. Operation staffs also do not have to do data entry repeatedly, and this may help to prevent many data entry errors. While EDI can greatly improve information transfer efficiency, it still has the following disadvantages:

1. EDI standards are too rigid and cannot be adjusted dynamically to meet the changes of the business environment.

2. EDI has high implementation costs. Many small or medium size businesses simply cannot afford it.

3. EDI mainly focuses on data transfer between enterprises, and mostly excludes end users from the Supply Chain.

4. EDI is a proprietary technique and not an open standard. It becomes a prohibitive factor for the expansion of enterprises.

5. When using EDI for data transfer, suppliers always act passively in data receiving roles. The transferring messages are relatively simple and do not have much diversity.

### SUMMARY OF THE INVENTION

The invention aims at resolving the preceding disadvantages and providing a supplier data transfer system and method. The primary object of the invention is to attack the common problem that now exists in the supply chain of many industries in which different vendors have different data file formats and interfaces, and suppliers have to waste a lot of time transferring data formats while receiving and sending orders. The invention offers a platform through an information intermediary, and uses software written by an enterprise end to set up a data transfer unit between the enterprise end and the information intermediary, to transfer different data formats received from different sources to formats compatible with the software systems at the enterprise end. Thus, data formats can be customized in a configure-to-order fashion through the data transfer unit, to ensure data compatibility regardless of where the sources of data transfer are.

The supplier data transfer system according to this invention consists of at least: an enterprise front end server for receiving and temporarily storing enterprise internal or external data, including: an active data warehouse server for actively capturing data during data transfer process and providing an interim storage space, and a data exchange security server for performing security authentication of the data captured by the active data warehouse server; an enterprise back end server for coordinating enterprise internal operations and providing an established data format for data transfer, including at least: an enterprise resource planning server to serve as the foundation of the enterprise total information systems and integrated results, and to assist managing production processes and regenerate the processes; an enterprise resource planning application server for providing a plurality of defined fields and formats to the suppliers for use, and also providing the suppliers self-define fields and formats; an enterprise resource planning document connector for linking data among the enterprise resource planning servers and providing a space to store the data transferred back from the enterprise front end server; a supply chain management server for linking the enterprise front end server, the enterprise back end server and the supplier ends to provide, through supply chain management, plans and controls in an electronic way the products and services, and information and money transaction so that the enterprise may get right products at the right places at the minimum cost with the minimum inventory and still offers customers excellent services thereby to utilize and distribute enterprise resources effectively and timely.

The supplier data transfer method of this invention includes at least the following steps: setting up data at an enterprise end which transfers the data through a network backbone to an information intermediary which in turn transfers the data through a global information network to a destination; a supplier end receiving data from or sending data to the destination through a browser, and delivering goods according contracts. When the enterprise end transfers the data through the network backbone to the information intermediary, the process further includes the following steps: establishing a data transfer split and a data transfer engine between the enterprise end server and the information intermediary; the data transfer engine linking a function library; through the function library transferring the formats required by different suppliers; and finally completing formats transfer.

The foregoing, as well as additional objects, features and advantages of this invention will be more readily apparent from the following detailed description, which proceeds with reference to the accompanying drawings.

### BRIEF DESCRIPTION OF THE DRAWINGS

FIG. 1 is a schematic view the system architecture of the supplier data transfer system of this invention.

FIG. 2 is a schematic view of the data transfer architecture of the enterprise end to the supplier ends according to this invention.

FIG. 3 is a functional block diagram of data transfer according to this invention.

FIG. 4 is the basic process flow of the supplier data transfer method of this invention.

### DESCRIPTION OF THE PREFERRED EMBODIMENT

This invention aims at providing a supplier data transfer system and method particularly targeting Business Process Reengineer (BPR) which is presently being widely advocated in the market place. The goal is to effectively utilize and manage enterprise resources, and to restructure supplier data transfer operation process to improve efficiency and reduce organization operating costs. This system is adapted for use in a supplier data transfer system to allow all messages in the purchase operation be transmitted timely, and to use an Enterprise Resource Planning (ERP) server to generate messages, and based on a File Transfer Protocol (FTP) to integrate effective data for the suppliers to deliver goods timely.

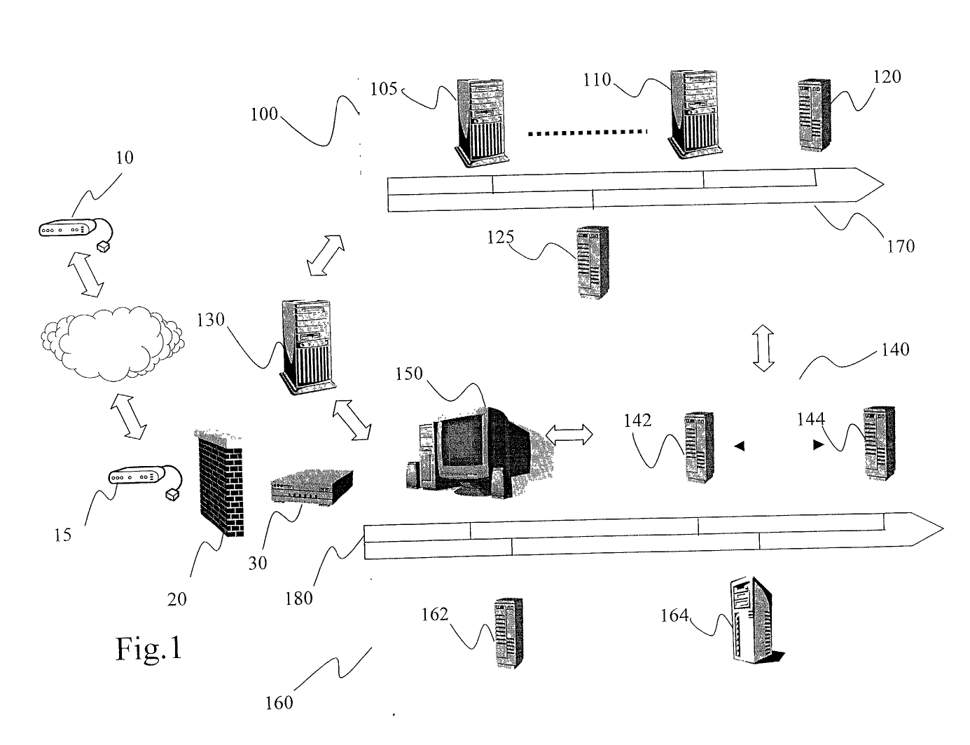

The feasibility and practicality of this invention will be elaborated by means of an embodiment depicted in the following. This system can integrate data of different suppliers so that the suppliers can timely match the production of the supply chain managers, and achieves the objects of increasing productivity and lowering inventory. FIG. 1 illustrates the system architecture of the supplier data transfer system of this invention. It comprises a first modem 10 links to second modem 15. The modems 10 and 15 may be dial-up modems, network (Local Area Network, LAN) modems, ISDN modems, cable modems or the like. Through the identity authentication of a Firewall 20 and a Router 30 enter into an enterprise internal network 170. The router 30 is for linking two network facilities and converting data packets to data frames to select paths. The enterprise internal network 170 is linked to a supplier end 150 and an information intermediary 160. The enterprise internal network consists of (1) an enterprise an enterprise backend server 100, (2) a supply chain management server 130 and (3) an enterprise front end server 140.

(1) The enterprise backend server 100 further includes (a) a first end ERP server 105, (b) a second end ERP server 110, (c) an ERP application server 120, and (d) an ERP Document Connector Server 125. Their function will be described as follows:

(a) The first end ERP server 105 and (b) the second end ERP server 110: Their main function is to provide a base for the entire enterprise information systems and to integrate the results. The servers will integrate whole operations of the enterprise, including human resources, finances, manufacturing, distribution, organization, and customers and suppliers communication, and assist and manage production processes and reengineer the processes.

(c) the ERP application server 120: Its main function is to provide a plurality of defined fields and formats, and to store the data of the first end ERP server 105 and the second end ERP server 110, and also provides a function to allow the supplier end 150 to select any of the defined fields and formats required, and further allows the supplier end 150 to define its own fields and formats when in use, thus may enhance the portability of the ERP application server. Then store the fields and formats in the information intermediary 160, and transmit back to the enterprise end 50 after data conversion.

(d) the ERP Document Connector Server 125: Its main function is to allow the data and documents of the first end ERP server 105 and the second end ERP server 110 stored in the ERP application server 120 to link to each other, and to store the data and messages sent back from the enterprise front end server 140 for the system to easily analyze and abstract useful data during integration, and to determine the final data storage location, or allows people in the enterprise to search and retrieve required information at the shortest time.

The servers of aforesaid (a), (b), (c) and (d) are linked to one another through an enterprise internal network (LAN) 170. The LAN 170 may be an Ethernet.

(2) The supply chain management server 130: Its main function is to link the enterprise front end server 140, enterprise back end server 100 and supplier end 150 to one another, and to provide, in an electronic way and through supply chain management, planning and control of products and services, and information and money transactions so that the enterprise may get the right products at the right places at the minimum cost with minimum inventory and still can offer customers excellent services, thereby utilizes and distributes enterprise resources (such as people, equipment, material, capital) effectively and timely. The Supply Chain means a network consisting of assembled individual entities that affects the execution of the processes which transfer materials from the beginning to become finished products at the end and finally deliver to customers.

(3) The enterprise front end server 140 consists of (a) an Active Data Warehouse (ADW) server 142 and (b) Security Data Exchange Server 144, which will be elaborated below:

(a) The ADW server 142: Its main function is to automatically capture data from a purchase data base 164 that were input by the supplier end 150, and temporarily store the data therein, and after analyzing and integrating, store the data back to the enterprise back end server 100. It also actively captures and temporarily stores data provided by the enterprise back end server 100, and after analyzing and integrating, stores the data in the information intermediary 160.

(b) The Security Data Exchange Server 144: Its main function is to perform security authentication on the data and messages actively captured by the ADW server 142 before storing. That's why the ADW server 142 has the temporarily storing process.

The supplier end 150 is a supplier and may input relative materials information through the Web site of the information intermediary 160.

The information intermediary 160 is a third-party authentication organization not belong to the suppliers or enterprises. It provides a platform for storing data of the suppliers and enterprises, and offers added value network function. It consists of (a) a purchase order Webquery server 162 and (b) a purchase data base 164, which will be elaborated as follows:

(a) The purchase order Webquery server 162: Its main function is to allow the supplier end 150 and enterprise end 50 to inquire purchase order processing progress on the Web site provided by the information intermediary 160. All the data are directly accessed from the purchase order data base 164.

(b) The purchase data base 164: Its main function is to store the customized fields and formats generated by the ERP application server 120 and actively captured by the ADW server 142 for the supplier end 150 to directly access the customized fields and formats from the data base for data entry use. If the customized fields and formats cannot meet requirements, suppliers can directly modify self-define fields. Another function is to store the data into the data base that are transferred from the enterprise end 50 and input by the supplier end.

Data transfer among the enterprise front server 140, supplier end 150 and information intermediary 160 are done through a network backbone 180.

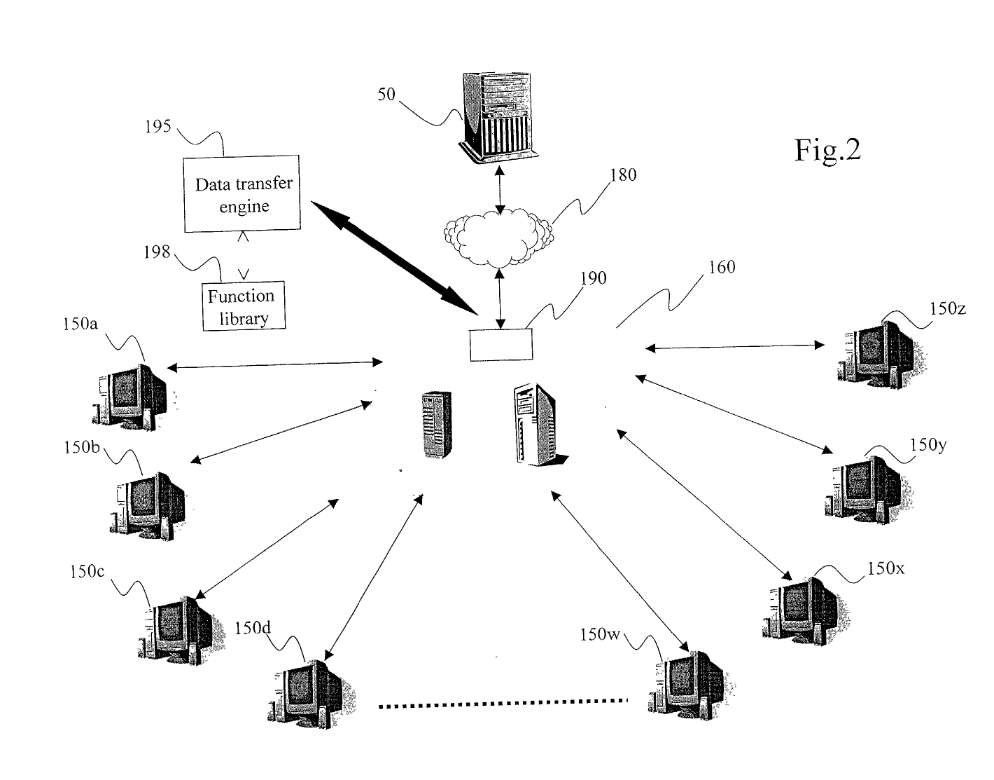

FIG. 2 shows the data transfer architecture of the enterprise end to supplier ends according to this invention. Details are described hereunder.

An enterprise end 50 links to an information intermediary 160 through a network backbone 180. The enterprise end 50, as mentioned before, consists of the enterprise back end server 100, supply chain management server 130 and enterprise front end server 140. The information intermediary 160 can link to a plurality of supplier ends 150a-150z concurrently. Between the enterprise end 50 and the information intermediary 160, there is a data transfer split 190 which further provides a data transfer engine 195.

The data transfer split 190 is setup at the enterprise end 50. Its main function is to transfer the data established by the enterprise end 50 to the data transfer engine 195 before transferring to the information intermediary 160.

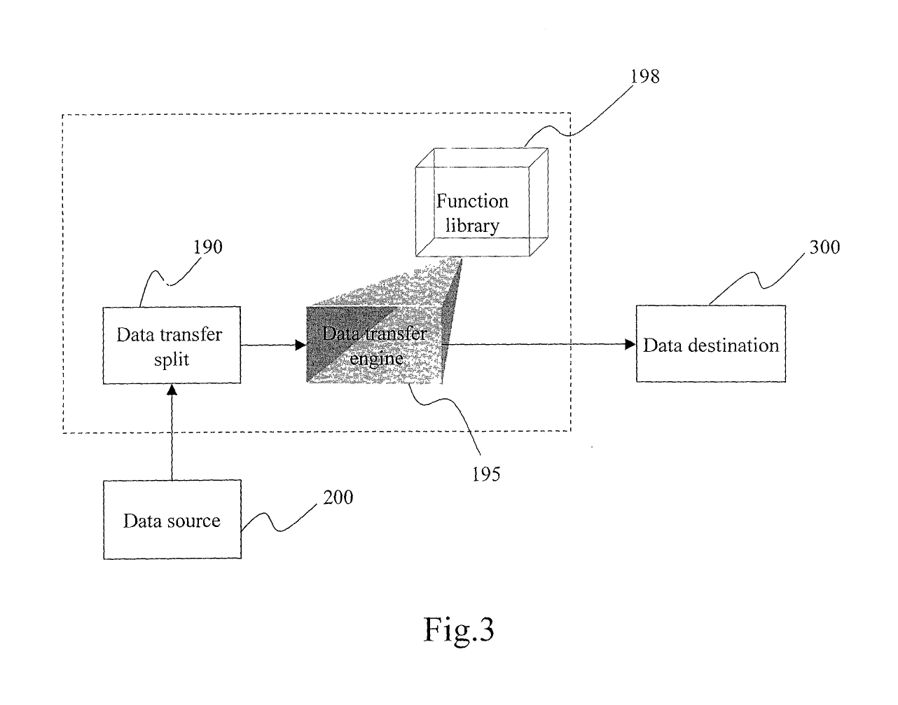

The data transfer engine 195 is mainly to link the data from the data transfer split 190 and map the data to a Function Library 198, and to perform format transfer with the data stored in the Function Library 198, and based on the fields and formats required by different suppliers to set up in a configure-to-order fashion, thereby to improve effectiveness. As different systems have different file data transfer formats, when the transferred data pass through the data transfer split 190, the data transfer engine 195 will perform data transfer once to meet the data format compatibility requirement. FIG. 3 shows the functional block diagram of data transfer according to this invention.

First, a data source 200 transfers data through a data transfer split 190. The data from the data source 200 then is transferred to a data transfer engine 195 and mapped to the function library 198, then get corresponding data formats from the function library and transfer the data to a data destination 300. The function library may be a Dynamic Link Library (DDL) for transferring data formats. The function library 198 employs an encoder or a compiler to generate object codes, then through function library management programs to convert the object codes to the function library formats for other application programs to link, thereby to send back to the data transfer engine 195. The enterprise end 50 and supplier end 150 can all be the data source 200 or data destination 300. When the enterprise end 50 is the data source 200, the supplier end 150 becomes the data destination 300. On the other hand, when the supplier end 150 is the data source 200, the enterprise end 50 becomes the data destination 300. Therefore, whichever is the data source, when passing through the data transfer split 190, data formats transfer will be performed to ensure data compatibility.

As mentioned above, the function and processes provided by the information intermediary 160 have same format, and cannot offer different fields and formats required by different suppliers. Hence the information intermediary 160 cannot fully attain its effectiveness. This invention offers a data transfer mode to resolve this problem. By using Configure to Order (CTO) concept, in addition to transmit data on the network, it also can setup different fields and formats according to different requirements so that suppliers can receive and deliver materials more efficiently and easily.

The method disclosed in this invention is to place conventional data transfer concept and architecture on the Web. It mainly employs the techniques among the Enterprise Resource Planning (ERP) and Supply Chain Management (SCM) and Information Intermediary to achieve the function of integrating the diverse data and instant data transfer. It can be used between the suppliers and enterprise end in the supply chain for the suppliers to receive data actively, and to transfer effective information directly according to requirements. In the mean time, it can also process in reverse by sending effective information from the suppliers to the enterprise end. It further establishes a data transfer unit at the authentication third-party between the supplier ends and enterprise end to facilitate data transfer.

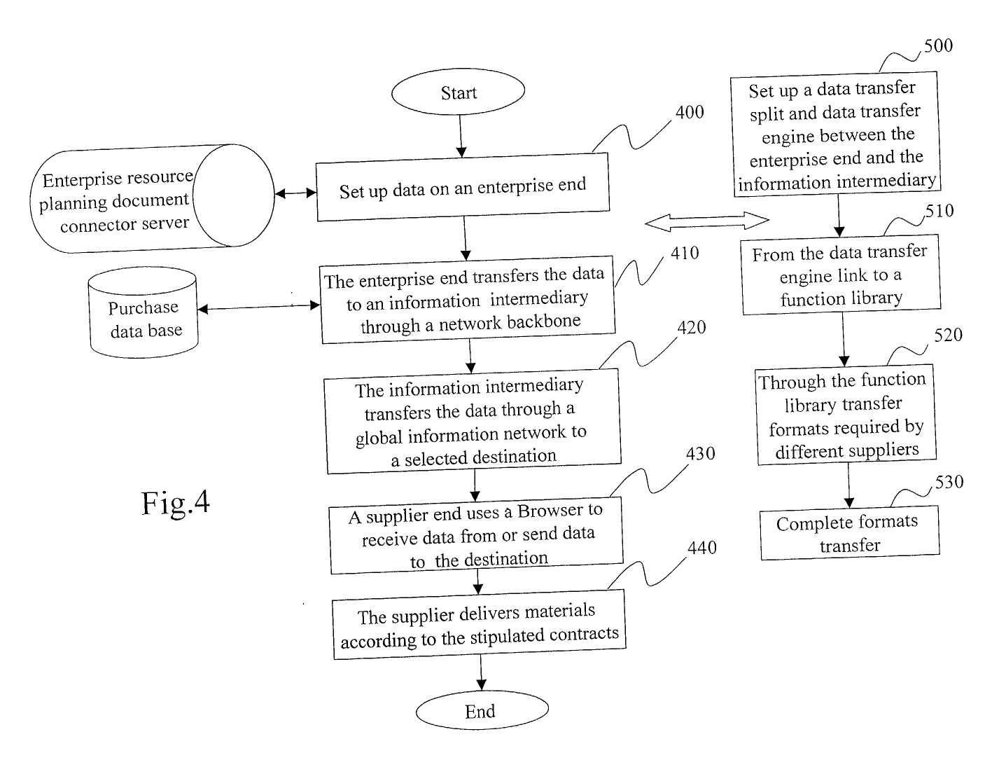

FIG. 4 illustrates the process flow of supplier data transfer method of this invention. Details will be elaborated as follows:

First, set up data at an enterprise end (step 400) which includes an enterprise front end server, an enterprise back end server and a supply chain management server. The data are stored in an ERP document connector server. Information of different requirements are generated through a plurality of ERP servers, and are transferred to an information intermediary by the enterprise end through a network backbone (step 410). The enterprise end uses an ERP server to generate information and based on a File Transfer Protocol (FTP) transfers the data through the network backbone to the information intermediary. The information intermediary stores the data in a purchase data base, and through a global information network transfers the data to a destination (step 420) for selected business entities to browse. A supplier end can receive data from and send data to the global information network through a Browser (step 430). Finally the supplier end delivers materials according to the contracts (step 440) to accomplish the object of data transfer.

As the information intermediary only provides a platform to the suppliers and enterprises for data transfer, and does not provide other different data transfer approaches to different suppliers, therefore data transfer can only be done by following the procedures from the step 400 to the step 440. This invention provides (at the step 410) a data format transfer during the enterprise end transfers the data through the network backbone to the information intermediary, thus can meet the requirements of different suppliers.

Therefore, before the enterprise end transferring data to the information intermediary, the enterprise end should set up a data transfer split and a data transfer engine between the enterprise end and the information intermediary (step 500). The data transfer engine is located in the data transfer split. When data are transferred to the information intermediary, through the data transfer split and from the data transfer engine linking to a function library (step 510), and through the function library transfer the data to the required formats for different suppliers (step 520), and finally complete the transfer format process (step 530). The process may return to the step 420 to proceed other remaining procedures. Hence based on the method of data format transfer set forth above, different data formats can be customized to meet the requirements of different suppliers thereby to achieve the object of transfer data format in a configure-to-order fashion.

While the preferred embodiment of this invention has been set forth for the purpose of disclosure, modifications of the disclosed embodiments of the invention as well as other embodiment thereof may occur to those skilled in the art. Accordingly, the appended claims are intended to cover all embodiments which do not depart from the spirit and scope of this invention.

What is claimed is:

1. A supplier data transfer system for use in an enterprise internal enterprise resources planning through an enterprise internal network to link to a network backbone and employing a platform provided by an information intermediary to integrate data between an enterprise end and a supplier end to complete data transfer in a configure-to-order fashion, the system comprising at least:
an enterprise front end server for receiving and temporarily storing enterprise internal and external data, including at least:
an active data warehouse server for actively capturing data during data transfer processes and providing a temporary storage space;
a security data exchange server for performing security authentication on the data actively captured by the active data warehouse server;
an enterprise back end server for coordinating enterprise internal operation to provide data formats for data transfer, including at least:
an enterprise resource planning server for serving as the base of the enterprise total information systems and integrating the results, and assisting management of production processes and reengineering the processes;
an enterprise resource planning application server for providing a plurality of defined fields and formats to the supplier end for using, and providing the supplier end self-define fields and formats;
an enterprise resource planning document connector server for linking data among the enterprise resource planning servers, and providing a space to store the data transferred back from the enterprise front end server; and
a supply chain management server for linking the enterprise front end server, the enterprise back end server and the supplier end, and through a supply chain management software to provide planning and control of products and services, and information and money exchanges.

2. The supplier data transfer system of claim 1, wherein the supplier end is allowed to input related messages of materials offered by the supplier at Web sites provided by the information intermediary.

3. The supplier data transfer system of claim 1, wherein the information intermediary is a third-party authentication organization not belong to the supplier and the enterprise, and provides a platform for storing data of the supplier and the enterprise that has added value network effect, and includes at least:
a purchase order Webquery server allowing the supplier end and the enterprise end to inquire order processing progress on the Web sites provided by the information intermediary; and
a purchase data base for providing a space to store data transferred from the enterprise end and data input by the supplier, the data being directly accessable.

4. The supplier data transfer system of claim 1, wherein the enterprise internal network is for linking the enterprise resource planning server, the enterprise resource planning application server and the enterprising resource planning document connector server, the enterprise internal network is Ethernet.

5. The supplier data transfer system of claim 1, wherein the network backbone is for linking the enterprise front end server, the supplier end and the information intermediary for performing data transfer process.

6. The supplier data transfer system of claim 1, wherein the enterprise end further has a data transfer split between the information intermediate and thereof for receiving data transferred from a data source, the data transfer split further including:
a data transfer engine for transferring formats of the data in the data transfer split, setting up fields and formats in a configure-to-order fashion based on the requirements of different suppliers, and sending the transferred data formats to a data destination; and
a function library for linking and mapping the data in the data transfer engine, using an encoder or a compiler to generate object codes, and through function library management programs transferring the object codes to function library formats to allow other application programs to link, and sending back to the data transfer engine.

7. The supplier data transfer system of claim 6, wherein the function library is a dynamic link library for transferring data formats.

8. The supplier data transfer system of claim 6, wherein the data source and the data destination are the enterprise end and the supplier end; when the enterprise end is the data source, the supplier end is the data destination; and when the supplier end is the data source, the enterprise end is the data destination.

9. The supplier data transfer system of claim 6, wherein the data transfer split adapts a configure-to-order (CTO) concept to complete network data transfer and based on the requirements of different suppliers to set up different formats and fields.

10. A supplier data transfer method using a technique among an enterprise resource planning (ERP) and a supply chain management (SCM) and an information intermediary, and applying to a supplier end and an enterprise end of a supply chain, the method comprising the following steps:
setting up data on an enterprise end;
transferring the data from the enterprise end through a network backbone to the information intermediary;
transferring the data from the information intermediary through a global information network to a destination;
receiving and sending data at the destination by the supplier end through a browser; and
delivering materials by the supplier end according to contracts.

11. The supplier data transfer method of claim 10, wherein the data at the setting up data on an enterprise end are stored in an enterprise resource planning document connector server, and using a plurality of enterprise resource planning servers to generate information of different requirements.

12. The supplier data transfer method of claim 10, wherein the step of transferring the data from the enterprise end through a network backbone to the information intermediary further includes the following steps:
setting up a data transfer split and a data transfer engine between the enterprise end server and the information intermediary;
linking the data transfer engine to a function library;
transferring through the function library to form formats required by different suppliers; and
completing formats transfer.

13. The supplier data transfer method of claim 12, wherein the setting up a data transfer split and a data transfer engine between the enterprise end server and the information intermediary is done through the enterprise end.

14. The supplier data transfer method of claim 12, wherein the linking of the linking the data transfer engine to a function library is done by mapping, the function library being a dynamic link library.

15. The supplier data transfer method of claim 12, wherein the transferring through the function library to form formats required by different suppliers is done by customizing according to different supplier ends to form data formats required by the supplier ends and accomplished in a configure-to-order fashion.

16. The supplier data transfer method of claim 10, wherein the enterprise end uses an enterprise resource planning server to generate information and based on a file transfer protocol (FTP) transfers the data from the enterprise end through the network backbone to the information intermediary, the information intermediary storing the data in a purchase data base.

17. The supplier data transfer method of claim 10, wherein the destination is a platform provided by the information intermediary and stores the data provided by the suppliers and the enterprise.
